(19) United States
(12) Patent Application Publication
(10) Pub. No.: US 2010/0144932 A1
(43) Pub. Date: Jun. 10, 2010

(54) Natural Fiber Reinforced Polylactic Acid Resin Composition and Molded Product Using the Same

(75) Inventors: Young-Chul KWON, Uiwang-si (KR); Chang-Do JUNG, Uiwang-si (KR); Hyung-Tak LEE, Uiwang-si (KR); Young-Kyu CHANG, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/633,822

(22) Filed: Dec. 9, 2009

(30) Foreign Application Priority Data
Dec. 9, 2008 (KR) 10-2008-0124878

(51) Int. Cl. C08L 1/02

(52) U.S. Cl. 524/35; 977/742

(57) ABSTRACT

Disclosed is a natural fiber reinforced polylactic acid resin composition that includes (A) a mixed resin including (A-1) a polylactic acid resin and (A-2) a natural fiber, (B) a coupling agent, and (C) carbon nanotubes.

### CROSS REFERENCE TO RELATED APPLICATIONS

This application claims priority to and the benefit of Korean Patent Application No. 10-2008-0124878 filed in the Korean Intellectual Property Office on Dec. 9, 2008, the entire disclosure of which is incorporated herein by reference.

### FIELD OF THE INVENTION

The present invention relates to a natural fiber reinforced polylactic acid resin composition and a molded product made using the same.

### BACKGROUND OF THE INVENTION

Recently, there has been increased interest in environmentally-friendly polymer materials. Several years ago, bio/photo-decomposing polymers such as biodegradable polymers, composting polymers, composite degradable polymers, and the like that are eco-friendly as waste drew attention and were highly developed.

However, such eco-friendly polymers have inadequate physical properties and poor workability, so it is inconvenient to process them using conventional techniques. Further the cost of such eco-friendly polymers is typically several times higher than the cost of conventional polymers. Accordingly, it has been difficult to develop markets for the eco-friendly products.

As polylactic acid is increasingly mass produced, the cost has recently decreased. Further there are more applications for polylactic acid due to improved workability and physical properties that are comparative to polyethylene terephthalate (PET). Accordingly, markets for polylactic acid resin are gradually increasing.

Polylactic acid has advantages such as low price and excellent workability, and can be composted, so it may be used in disposable products such as food packaging. Further, there is active research directed to the development of products including polylactic acid for use in electronic devices or automobile interior or exterior materials, including efforts by, Japan Toyota with NEC.

However, since conventional polylactic acid resin lacks formability, mechanical strength, and heat resistance, the resultant thin film product is fragile and has poor heat resistance. Accordingly, products molded therefrom can be deformed at an outside temperature of 60° C. or more. In addition, if conventional polylactic acid resin is used as a case for electronic products, the material should have antistatic properties. However, if conventional carbon black is added to polylactic acid it is difficult to disperse therein, and it can deteriorate mechanical strength and cause a poor appearance.

Japanese Patent Laid-Open Publication No. 2005-220177, No. 2005-200517, and No. 2005-336220 disclose mixing polylactic acid with glass fiber to improve both heat resistance and mechanical strength. The glass fiber, however, is not bio-decomposed (not biodegradable) after disposal.

Japanese Patent Laid-Open Publication No. 2005-105245 and No. 2005-60556 disclose a method of mixing natural fiber with polylactic acid resin in order to improve eco-friendliness, but the composition has limited improved heat resistance and mechanical strength, and a resultant molded product is discolored by pyrolyzing lignin during the molding process.

### SUMMARY OF THE INVENTION

One aspect of the present invention provides a natural fiber reinforced polylactic acid resin composition that can have an excellent balance of properties such as mechanical strength, heat resistance, electrical conductivity, and workability.

Another aspect of the present invention provides a molded product made using the natural fiber reinforced polylactic acid resin composition.

According to one aspect of the present invention, a natural fiber reinforced polylactic acid resin composition is provided that includes: (A) a mixed resin including (A-1) about 50 to about 95 wt % of a polylactic acid resin and (A-2) about 5 to about 50 wt % of a natural fiber; (B) about 0.01 to about 10 parts by weight of a coupling agent based on about 100 parts by weight of the mixed resin; and (C) about 0.05 to about 10 parts by weight of carbon nanotubes based on about 100 parts by weight of the mixed resin.

The polylactic acid resin includes a repeating unit derived from a lactic acid comprising an L-lactic acid, a D-lactic acid, an L,D-lactic acid, or a combination thereof. The polylactic acid resin may include a repeating unit derived from an L-lactic acid in an amount of about 95 to about 100 wt % and a repeating unit derived from a D-lactic acid in an amount of about 0 to about 5 wt %. The polylactic acid resin may have a weight average molecular weight of about 80,000 to about 300,000 g/mol.

The natural fiber can include a bast fiber and can include about 95 wt % or more of cellulose. The natural fiber can have an average length of about 1 to about 100 mm and an average diameter of about 0.1 to about 100 μm.

The coupling agent can include a silane-based coupling agent, a titanium-based coupling agent, a zirconium-based coupling agent, or a combination thereof. The silane-based coupling agent can include 3-glycidoxypropyl trimethoxy silane, 3-glycidoxypropylmethyl dimethoxy silane, 2-(3,4-epoxycyclohexyl)ethyl trimethoxy silane, 3-methacryloxyl propyl trimethoxy silane, or a combination thereof.

The carbon nanotubes can have a diameter of about 1 to about 100 nm and a length of about 0.1 to about 25 μm. The carbon nanotubes can have an aspect ratio (L/D) of about 500 to about 10,000.

According to another aspect of the present invention, a molded product made using the natural fiber reinforced polylactic acid resin composition is provided.

Hereinafter, further aspects of the present invention will be described in detail.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A natural fiber reinforced polylactic acid resin composition according to one embodiment includes: (A) a mixed resin including (A-1) about 50 to about 95 wt % of a polylactic acid resin and (A-2) about 5 to about 50 wt % of a natural fiber; (B) about 0.01 to about 10 parts by weight of a coupling agent based on about 100 parts by weight of the mixed resin; and (C) about 0.05 to about 10 parts by weight of carbon nanotubes based on about 100 parts by weight of the mixed resin.

Exemplary components included in the natural fiber reinforced polylactic acid resin composition according to embodiments will hereinafter be described in detail. However, these embodiments are only exemplary, and the present invention is not limited thereto.

(A) Mixed Resin

(A-1) Polylactic Acid Resin

In general, polylactic acid resin is a commercially available polyester-based resin made using lactic acid obtained by decomposing corn starch of biomass as a monomer.

The polylactic acid resin can include a repeating unit derived from a lactic acid comprising an L-lactic acid, a D-lactic acid, an L,D-lactic acid, or a combination thereof.

The polylactic acid resin may include a repeating unit derived from an L-lactic acid in an amount of about 95 wt % or more, which can provide a good balance between heat resistance and formability. In one embodiment, the polylactic acid resin may include a repeating unit derived from an L-lactic acid in an amount of about 95 to about 100 wt % and a repeating unit derived from a D-lactic acid in an amount of about 0 to about 5 wt %. In one embodiment, the polylactic acid resin may include a repeating unit derived from an L-lactic acid in an amount of about 98 to about 99.99 wt % and a repeating unit derived from a D-lactic acid in an amount of about 0.01 to about 2 wt %. When the polylactic acid resin includes repeating units derived from L-lactic acid and D-lactic in the amounts noted herein, the polylactic acid resin can exhibit excellent hydrolysis resistance as well as a good balance between heat resistance and formability.

There is no particular limit on the molecular weight or molecular weight distribution of the polylactic acid resin, as long as the polylactic acid resin can be molded. In one embodiment, the polylactic acid resin can have a weight average molecular weight of more than about 80,000 g/mol, and in another embodiment, about 80,000 to about 300,000 g/mol. When the polylactic acid resin has a weight average molecular weight within the above range, molded products with balanced mechanical strength and heat resistance may be provided.

The polylactic acid resin can be a polylactic acid homopolymer, a polylactic acid copolymer, or a combination thereof.

The polylactic acid homopolymer may be prepared through ring-opening polymerization of a lactic acid comprising L-lactic acid, D-lactic acid, or a combination thereof.

The polylactic acid copolymer may be a random or block copolymer with a component that is capable of being copolymerized with the polylactic acid polymer. The component that is capable of being copolymerized with the polylactic acid polymer may include a compound having at least two functional groups capable of forming an ester-bond within the molecule structure.

Examples of compounds having at least two functional groups capable of forming an ester-bond within the molecule include without limitation (i) dicarboxylic acids, (ii) polyhydric alcohols, (iii) hydroxy carbonic acids excluding lactic acid, (iv) lactones, and (v) polyesters, polyethers, polycarbonates, and the like, which are derived from the above compounds.

Exemplary dicarboxylic acids (i) can include without limitation C4 to C50 linear or branched saturated or unsaturated aliphatic dicarboxylic acids, C8 to C20 aromatic dicarboxylic acids, polyether dicarboxylic acids, and the like, and combinations thereof.

Exemplary aliphatic dicarboxylic acids may include without limitation succinic acid, adipic acid, sebacin acid, decane dicarboxylic acid, and the like, and combinations thereof. Exemplary aromatic dicarboxylic acids may include without limitation phthalic acid, terephthalic acid, isophthalic acid, and the like, and combinations thereof. Exemplary polyether dicarboxylic acids may include without limitation polyalkylene ethers such as polyethylene glycol, polypropylene glycol, polybutylene glycol, polyethylene polypropylene glycol, and the like, with a carboxyl methyl group at both ends of the polyalkylene ether, and combinations thereof.

Exemplary polyhydric alcohols (ii) can include without limitation aliphatic polyols, aromatic polyhydric alcohols, polyalkylene ethers, and the like, and combinations thereof.

Exemplary aliphatic polyols can include without limitation C2 to C50 aliphatic polyols including 2 to 4 hydroxy groups such as butane diol, hexane diol, octane diol, decane diol, 1,4-cyclohexanedimetanol, glycerine, sorbitan, trimethylolpropane, neopentyl glycol, and the like, and combinations thereof.

Exemplary aromatic polyhydric alcohols may include without limitation C6 to C20 aromatic diols such as bis-hydroxy methyl benzene, hydroquinone, and the like, and aromatic diols prepared by additionally reacting a C2 to C4 alkylene oxide such as ethylene oxide, propylene oxide, butylene oxide, and the like with bisphenols such as bisphenol A, bisphenol F, and the like, and combinations thereof.

Exemplary polyalkylene ethers may include without limitation ether glycols such as ethylene glycol, propylene glycol, diethylene glycol, triethylene glycol, polyethylene glycol, polypropylene glycol, and the like, and combinations thereof.

Exemplary hydroxy carboxylic acids (iii) excluding lactic acid may include without limitation C3 to C10 hydroxy carboxylic acids such as glycolic acid, hydroxy butyl carboxylic acid, 6-hydroxy caproic acid, and the like, and combinations thereof.

Exemplary lactones (iv) may include without limitation glycolide, ε-caprolactone glycolide, ε-caprolactone, β-propinolactone, δ-butyrolactone, β-butyrolactone, γ-butyrolactone, δ-valerolactone, and the like, and combinations thereof.

The polyester, polyether, or polycarbonate (v) can be any one conventionally used for preparing a lactic acid copolymer without limitation, and in one embodiment, polyester may be used.

Exemplary polyesters may include without limitation aliphatic polyesters prepared from an aliphatic dicarboxylic acid and an aliphatic diol.

Exemplary aliphatic dicarboxylic acids may include without limitation succinic acid, adipic acid, sebacin acid, decanedicarboxylic acid, and the like, and combinations thereof. Exemplary aliphatic diols may include without limitation C2 to C20 aliphatic diols such as ethylene glycol, propane diol, butane diol, hexane diol, octane diol, and the like, polyalkylene ethers (homopolymer or copolymer) such as polyethylene glycol, polypropylene glycol, polybutylene glycol, and the like, polyalkylene carbonates, and the like, and combinations thereof.

The mixed resin may include the polylactic acid resin in an amount of about 50 to about 95 wt %, for example about 60 to about 90 wt %, based on the total weight of the mixed resin of the polylactic acid resin and natural fiber. When the mixed resin includes the polylactic acid resin in an amount within the above ranges, the composition can exhibit excellent heat resistance and mechanical strength, and improved environmentally-friendly effects.

(A-2) Natural Fiber

The natural fiber according to one embodiment is included in polylactic acid resin as a reinforcing agent, and can include a bast fiber obtained from bast having flexibility among bast and xylem of a plant stem.

The bast fiber can be useful as a polymer composite material, and can include flax, hemp, jute, kenaf, ramie, curaua, and the like, and combinations thereof.

The natural fiber may include cellulose in an amount of about 95 wt % or more. Generally, the cell membrane of a fiber cell is mainly composed of cellulose, lignin, and semicellulose. When the natural fiber includes cellulose in an amount of about 95 wt % or more by sufficiently removing lignin and semicellulose, the heat resistance and mechanical strength can be improved, and discoloration of a molded product caused by heat-decomposing lignin during a molding process can also be reduced.

The natural fiber can have an average length of about 1 to about 100 mm, for example about 2 to about 50 mm. When the natural fiber has an average length within these ranges, the mechanical strength such as tensile strength, flexural strength, flexural modulus and the like can be improved, and the workability and appearance characteristics of the natural fiber can also be improved.

The natural fiber can have an average diameter of about 0.1 to about 100 μm, for example about 0.5 to about 50 μm. When the natural fiber has an average diameter within these ranges, the workability and surface gloss can be improved.

According to one embodiment, the natural fiber may be subjected to surface treatment as known in the art, such as a plasma surface treatment or alkali surface treatment, to improve the wetting property between the natural fiber and the polylactic acid resin.

According to one embodiment, the mixed resin may include the natural fiber in an amount of about 5 to about 50 wt %, for example about 10 to about 40 wt %, based on the total weight of the mixed resin of polylactic acid resin and natural fiber. When the natural fiber is included within these ranges, the mechanical strength and workability of the composition can be improved.

According to one embodiment, the disadvantage of mechanical strength and heat resistance of polylactic acid resin is compensated for by mixing the natural fiber with the polylactic acid resin. In addition, the surface gloss and color can be improved.

(B) Coupling Agent

According to one embodiment, the coupling agent may include a reactive coupling agent.

Exemplary reactive coupling agents may include without limitation silane-based coupling agents, titanium-based coupling agents, zirconium-based coupling agents, and the like, and combinations thereof. In one embodiment the reactive coupling agent may include a silane-based coupling agent, and in another embodiment, a silane-based coupling agent having an epoxy terminal group.

Exemplary silane-based coupling agents include without limitation 3-glycidoxypropyltrimethoxy silane, 3-glycidoxypropylmethyl dimethoxy silane, 2-(3,4-epoxycyclohexyl)ethyltrimethoxy silane, 3-methacryloxy propyltrimethoxy silane, and the like, and combinations thereof.

According to one embodiment, the compatibility between polylactic acid resin and natural fiber can be improved by mixing polylactic acid resin and natural fiber together with the coupling agent, to improve mechanical strength (which is a limitation of conventional polylactic acid resin).

According to one embodiment, the natural fiber reinforced polylactic acid resin composition may include the coupling agent in an amount of about 0.01 to about 10 parts by weight, for example about 0.1 to about 5 parts by weight, based on about 100 parts by weight of the mixed resin including polylactic acid resin and natural fiber. When the coupling agent is included in an amount within these ranges, the mechanical strength can be improved, and the viscosity can be suitably maintained to improve formability.

(C) Carbon Nanotubes

The carbon nanotubes according to one embodiment can have mechanical characteristics of excellent mechanical strength and a high Young's modulus, and a high aspect ratio (L/D); in addition, the carbon nanotubes can have excellent electrical conductivity and thermal stability.

When the carbon nanotubes are added to the polymer composite, it is possible to provide a polymer composite in which mechanical, thermal, and electrical characteristics are improved.

The carbon nanotubes may be synthesized using known techniques, such as arc-discharge, pyrolysis, laser vaporization, plasma enhanced chemical vapor deposition (PECVD), thermal chemical vapor deposition, electrolysis, flame synthesis, and the like.

The carbon nanotubes may be classified into single wall carbon nanotubes, double wall carbon nanotubes, and multi-wall carbon nanotubes depending upon the number of walls. The natural fiber reinforced polylactic acid resin composition of the invention can include multi-wall carbon nanotubes, but the invention is not limited thereto.

The carbon nanotubes can have a diameter of about 1 to about 100 nm, for example about 2 to about 50 nm.

The carbon nanotubes can have a length of about 0.1 to about 25 μm, for example about 0.5 to about 20 μm. When the carbon nanotubes have a length within these ranges, the carbon nanotubes can provide excellent electrical conductivity.

According to one embodiment, the carbon nanotubes may have an aspect ratio (L/D) of about 100 or more, for example about 500 to about 10,000 due to the diameter and the length of the carbon nanotubes. When the carbon nanotubes have an aspect ratio within these ranges, they may impart excellent electrical conductivity to the composition even when adding a small amount.

According to one embodiment, the natural fiber reinforced polylactic acid resin composition can include the carbon nanotubes in an amount of about 0.05 to about 10 parts by weight, for example about 0.1 to about 5 parts by weight, based on about 100 parts by weight of the mixed resin including the polylactic acid resin and natural fiber. When the carbon nanotubes are included within these ranges, the composition may have excellent electrical conductivity.

(D) Other Additives

The natural fiber reinforced polylactic acid resin composition according to one embodiment may further include one or more additives.

Exemplary additives may include without limitation antibacterial agents, heat stabilizers, antioxidants, release agents, light stabilizers, compatibilizers, inorganic material additives, surfactants, coupling agents, plasticizers, admixtures, colorants, stabilizers, lubricants, antistatic agents, flame-proofing agents, weather-resistance agents, ultraviolet (UV) ray blocking agents, fillers, nucleating agents, adhesion aids, adhesives, and the like, and combinations thereof.

Exemplary antioxidants may include without limitation phenol-type antioxidants, phosphite-type antioxidants, thioether-type antioxidants, amine-type antioxidants, and the like, and combinations thereof. Exemplary release agents may include without limitation fluorine-containing polymers, silicone oils, metal salts of stearic acid, metal salts of montanic acid, montanic acid ester waxes, polyethylene waxes, and the like, and combinations thereof. Exemplary weather-resistance agents may include without limitation benzophenone-type weather-resistance agents, amine-type weather-resistance agents, and the like, and combinations thereof. Exemplary colorants may include without limitation dyes, pigments, and the like, and combinations thereof. Exemplary ultraviolet (UV) ray blocking agents may include without limitation titanium oxide (TiO₂), carbon black, and the like, and combinations thereof. Exemplary fillers may include without limitation glass fiber, carbon fiber, silica, mica, alumina, clay, calcium carbonate, sulfuric acid calcium, glass beads, and the like, and combinations thereof. When these fillers are added, they can improve properties such as mechanical strength, heat resistance, and the like. In addition, exemplary nucleating agents may include without limitation talc, clay, and the like, and combinations thereof.

Another embodiment provides a product molded of the above natural fiber reinforced polylactic acid resin composition.

The natural fiber reinforced polylactic acid resin composition may be used to manufacture a molded product requiring good mechanical strength and heat resistance, for example, automobile parts, machine parts, electronic parts, office machines such as computers, and miscellaneous parts. In particular, it can be used for housings for electronics such as televisions, computers, printers, washing machines, cassette players, audio equipment, game devices, and the like.

The following examples illustrate the present invention in more detail. However, they are exemplary embodiments and are not limiting.

### Examples

A natural fiber reinforced polylactic acid resin composition according to one embodiment includes each component as follows.

(A) Mixed Resin

(A-1) Polylactic Acid Resin

4032D manufactured by United State NatureWorks LLC is used as the polylactic acid resin.

(A-2) Natural Fiber

The natural fiber is made from hemp and includes natural fiber having the following cellulose average amount, average length, average diameter, and surface treatment condition.

(A-2-1) Natural fiber having an cellulose average amount of 98 wt %, an average length of 5 mm, and average diameter of 10 μm, and no surface treatment.

(A-2-2) Natural fiber having a cellulose average amount of 98 wt %, an average length of 5 mm, an average diameter of 10 μm, and alkali surface treatment.

(B) Coupling Agent

3-glycidoxypropyltrimethoxy silane manufactured by Kenrich petrochemicals is used as the coupling agent.

(C) Carbon Nanotubes

Multi-wall carbon nanotubes (NC 700) manufactured by Belgium Nanocyl having a diameter of 10 to 15 nm and a length of 1 to 25 μm are used.

(C′) Carbon Black

Acetylene black is used as carbon black in a Comparative Example.

### Examples 1 to 5 and Comparative Examples 1 to 3

Resin compositions according to Examples 1 to 5 and Comparative Examples 1 to 3 are prepared using the above-described components in a composition ratio provided in the following Table 1.

Each component is added into a mixer in amounts shown in the following Table 1, and then extruded with a twin screw extruder having L/D=35, φ=45 mm to provide a pellet extrusion.

[Experimental Example]

The pellets according to Examples 1 to 5 and Comparative Examples 1 to 3 are dried at 80° C. for 4 hours and then extruded by using an injection molding machine with injection capability of 6 oz. to prepare specimens. The injection molding machine is set to have a cylinder temperature of 190° C., a molding temperature of 80° C., and a molding cycle of 120 seconds. The properties of the specimens are measured in accordance with the following methods. The results are provided in the following Table 2.

(1) Tensile strength: measured according to ASTM D638.

(2) Flexural strength: measured according to ASTM D790.

(3) Flexural modulus: measured according to ASTM D790.

(4) Thermal distortion temperature (HDT): measured according to ASTM D648.

(5) Sheet resistance: measured using an ohmmeter.

TABLE 1

| | | | | | | | | | Comparative | | |
|---|---|---|---|---|---|---|---|---|---|---|---|
| | | | | Examples | | | | | Examples | | |
| | | | unit | 1 | 2 | 3 | 4 | 5 | 1 | 2 | 3 |
| (A) | (A-1) | | wt % | 90 | 80 | 70 | 60 | 80 | 100 | 80 | 80 |
| mixed | polylactic acid | | | | | | | | | | |
| resin | resin | | | | | | | | | | |
| | (A-2) | (A-2-1) | wt % | 10 | 20 | 30 | 40 | — | — | 20 | 20 |
| | natural | (A-2-2) | wt % | — | — | — | — | 20 | — | — | — |
| | fiber | | | | | | | | | | |

| | | | | | | | | | |
|---|---|---|---|---|---|---|---|---|---|
| (B) coupling agent | parts by | 0.2 | 0.2 | 0.2 | 0.2 | 0.2 | 0.2 | 0.2 | 0.2 |
| | weight* | | | | | | | | |
| (C) carbon nanotubes | parts by | 2 | 2 | 2 | 2 | 2 | 2 | — | — |
| | weight* | | | | | | | | |
| (C′) carbon black | parts by | — | — | — | — | — | — | — | 20 |
| | weight* | | | | | | | | |
| tensile strength | kgf/cm² | 760 | 1100 | 1355 | 550 | 1275 | 400 | 1130 | 780 |
| flexural strength | kgf/cm² | 1300 | 1625 | 2005 | 823 | 1590 | 625 | 1580 | 970 |
| flexural modulus | kgf/cm² | 56700 | 75418 | 96454 | 127486 | 78455 | 23360 | 76250 | 32168 |
| thermal distortion | ° C. | 68 | 76 | 105 | 105 | 80 | 54 | 76 | 65 |
| temperature | | | | | | | | | |
| sheet resistance | Ω/sq | 10⁷ | 10⁶ | 10⁵ | 10⁵ | 10⁶ | 10⁸ | — | 10¹⁰ |

*Parts by weight: the amount based on 100 parts by weight of the mixed resin (A).

As shown in Table 1, Examples 1 to 5 including polylactic acid resin, a natural fiber, a coupling agent, and carbon nanotubes exhibit an excellent balance of physical properties including mechanical strength, heat resistance, electrical conductivity, and workability.

In contrast, Comparative Example 1 including no natural fiber exhibits significantly deteriorated mechanical strength, heat resistance, and electrical conductivity. In addition, Comparative Example 2 including no carbon nanotubes exhibits no electrical conductivity characteristics. Comparative Example 3 including carbon black instead of carbon nanotubes exhibits deteriorated mechanical strength and heat resistance.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A natural fiber reinforced polylactic acid resin composition, comprising:
(A) a mixed resin including (A-1) about 50 to about 95 wt % of a polylactic acid resin and (A-2) about 5 to about 50 wt % of a natural fiber;
(B) about 0.01 to about 10 parts by weight of a coupling agent based on about 100 parts by weight of the mixed resin; and
(C) about 0.05 to about 10 parts by weight of carbon nanotubes based on about 100 parts by weight of the mixed resin.

2. The natural fiber reinforced polylactic acid resin composition of claim 1, wherein the polylactic acid resin comprises a repeating unit derived from an L-lactic acid, a D-lactic acid, an L,D-lactic acid, or a combination thereof.

3. The natural fiber reinforced polylactic acid resin composition of claim 1, wherein the polylactic acid resin comprises a repeating unit derived from an L-lactic acid in an amount of about 95 to about 100 wt % and a repeating unit derived from a D-lactic acid in an amount of about 0 to about 5 wt %.

4. The natural fiber reinforced polylactic acid resin composition of claim 1, wherein the polylactic acid resin has a weight average molecular weight of about 80,000 to about 300,000 g/mol.

5. The natural fiber reinforced polylactic acid resin composition of claim 1, wherein the natural fiber comprises a bast fiber.

6. The natural fiber reinforced polylactic acid resin composition of claim 1, wherein the natural fiber comprises about 95 wt % or more of cellulose.

7. The natural fiber reinforced polylactic acid resin composition of claim 1, wherein the natural fiber has an average length of about 1 to about 100 mm.

8. The natural fiber reinforced polylactic acid resin composition of claim 1, wherein the natural fiber has an average diameter of about 0.1 to about 100 μm.

9. The natural fiber reinforced polylactic acid resin composition of claim 1, wherein the coupling agent comprises a silane-based coupling agent, a titanium-based coupling agent, a zirconium-based coupling agent, or a combination thereof.

10. The natural fiber reinforced polylactic acid resin composition of claim 9, wherein the silane-based coupling agent comprises 3-glycidoxypropyl trimethoxy silane, 3-glycidoxypropylmethyl dimethoxy silane, 2-(3,4-epoxycyclohexyl)ethyl trimethoxy silane, 3-methacryloxyl propyl trimethoxy silane, or a combination thereof.

11. The natural fiber reinforced polylactic acid resin composition of claim 1, wherein the carbon nanotubes have a diameter of about 1 to about 100 nm.

12. The natural fiber reinforced polylactic acid resin composition of claim 1, wherein the carbon nanotubes have a length of about 0.1 to about 25 μm.

13. The natural fiber reinforced polylactic acid resin composition of claim 1, wherein the carbon nanotubes have an aspect ratio (L/D) of about 500 to about 10,000.

14. A molded product made using the natural fiber reinforced polylactic acid resin composition according to claim 1.
